(19) United States
(12) Patent Application Publication
(10) Pub. No.: US 2007/0193997 A1
(43) Pub. Date: Aug. 23, 2007

(54) Cooling system

(76) Inventors: Jonas Nyhlen, Arvika (SE); Ann-Louise Wernby, Bor (SE); Kent Olofsson, Charlottenberg (SE)

Correspondence Address: HARNESS, DICKEY & PIERCE, P.L.C., P.O. BOX 8910, RESTON, VA, 20195, US

(21) Appl. No.: 10/573,819

(22) PCT Filed: Sep. 15, 2004
(86) PCT No.: PCT/SE04/01319

§ 371 Date: Dec. 19, 2006

(30) Foreign Application Priority Data
Oct. 1, 2003 (SE) 0302598-8

(51) Int. Cl. H05B 3/00; A47F 3/04; H05B 1/02; H05B 3/06

(52) U.S. Cl. 219/214; 219/218; 219/492; 219/531; 62/248

(57) ABSTRACT

A system in connection with a cold-storage/freezer space (1), said cold-storage freezer space (1) comprising at least one door (2) with at least two transparent sheets (3), a conductive layer being placed on one of the sheets (3) to function as a heating element to keep said sheets (3) free of condensation, comprises a moisture sensor (6) and a temperature sensor (5) on the side which is warm when using the cold-storage/freezer space (1). Said sensors (5, 6) are connected to a control unit (7), said control unit (7) regulating the supply of power to said conductive layer. The system also comprises a second temperature sensor (4) in said cold-storage/freezer space (1), i.e. on the side which is cold when using the cold-storage/freezer space (1), said second temperature sensor (4) being connected to said control unit (7).

### FIELD OF THE INVENTION

The present invention relates to a system in connection with a cold-storage/freezer space, said cold-storage/freezer space comprising at least one door with at least two transparent sheets, a conductive layer being placed on one of the sheets to function as a heating element to keep said sheets free of condensation, the system comprising a moisture sensor and a temperature sensor on the side which is warm when using the cold-storage/freezer space, said sensors being connected to a control unit, said control unit regulating the supply of power to said conductive layer.

### BACKGROUND ART

In order to keep doors of refrigerated spaces free of condensation, the outermost sheet of the door is usually heated enough for its surface temperature to be higher than the dew point of the ambient air. The supplied power is usually constant and calculated for the worst case, i.e. that a maximum constant dew point is assumed to prevail. This solution thus implies that the sheet of the door is most of the time heated excessively. A plurality of systems have been suggested to control heating and save energy.

Such a system is of the type stated by way of introduction and known from, for instance, U.S. Pat. No. 5,778,689. This system calculates the dew point by means of said moisture and temperature sensors. The higher the calculated dew point the more power is supplied to the door to keep it free of condensation. With a very low water content of the air no power at best has to be supplied to the door to keep it free of condensation.

### SUMMARY OF THE INVENTION

The object of the present invention is to provide a system which requires less energy to keep doors of cold-storage/freezer spaces free of condensation.

According to the invention, this object is achieved by the system of the type stated by way of introduction being given the features that are evident from claim 1. Preferred embodiments of the system are defined by the dependent claims.

The inventive system in connection with the cold-storage/freezer space thus comprises at least one door with at least two transparent sheets, a conductive layer being placed on one of the sheets to function as a heating element to keep said sheets free of condensation, the system comprising a moisture sensor and a temperature sensor on the side which is warm when using the cold-storage/freezer space, said sensors being connected to a control unit, said control unit regulating the supply of power to said conductive layer, wherein the system also comprises a second temperature sensor in said cold-storage/freezer space, i.e. on the side which is cold when using the cold-storage/freezer space, said second temperature sensor being connected to said control unit. In this manner a system is obtained, which requires very little energy and which continuously can keep the doors free of condensation. By continuously monitoring the temperature of the warm as well as the cold side and the dew point on the warm side, it is possible to continuously adapt the system to different temperature conditions. When, for instance, a door of a cold-storage/freezer space is being opened frequently, it is possible for the temperature in the cold-storage/freezer space to rise somewhat. Taking the temperature increase into consideration, it is thus possible to reduce the supply of power and still keep the door free of condensation. An experience curve is preferably introduced for each door, or alternatively a change-over switch, so that the same unit can be used for different types of doors and different operating conditions. The only setting which thus is made in the system is the relationship of dew point and prevailing temperatures on the warm and cold sides to the heat-conducting properties and size of the door. Preferably the control unit is programmed to keep the surface temperature on the outside of the sheet on the warm side above the dew point of the ambient air. It is also possible to arrange some type of controls for making fine adjustments later when the door is already mounted in a cold-storage/freezer space. The used term “layer” is intended to comprise, for instance, thin film coating, film with adhesive, heating coils and other “layers” known on the market, which can conduct current for the purpose of heating transparent sheets.

When new cold-storage doors are mounted in a cold-storage/freezer space, the control unit can be arranged either in a doorframe or as a separate unit in or outside the cold-storage/freezer space. The advantage of arranging the control unit in the doorframe is thus the saving of space. However, if the control system according to the present invention is to be installed in an existing cold-storage/freezer space with doors, it is in many cases more practical and economical to have a separate unit, which also minimises the modification required. The control unit is then suitably arranged on the outside of the cold-storage/freezer space to facilitate access.

Preferably a plug interface is connected to the control unit in order to allow reprogramming. If new software is developed, the software in the system can easily be updated by means of the plug interface. In some situations, for instance when servicing the installation, it may be convenient to easily be able to make a connection instead of having to dismount the control unit. It would also be possible to arrange a system that can be remote controlled by a computer for instance.

To prevent mechanical damage when handling objects in the vicinity of the door, the temperature sensor on the cold side is preferably arranged in the upper part of the doorframe.

Moreover, indicator lights (light-emitting diodes) are preferably arranged to indicate the operating status of the system to make monitoring easy for the user. A certain signal may indicate, for instance, that the system functions properly and another signal that an error has occurred.

The transparent sheet is preferably made of glass since glass is usually more scratch-resistant, but it is also possible to use certain heat-resisting plastics.

### BRIEF DESCRIPTION OF THE FIGURE

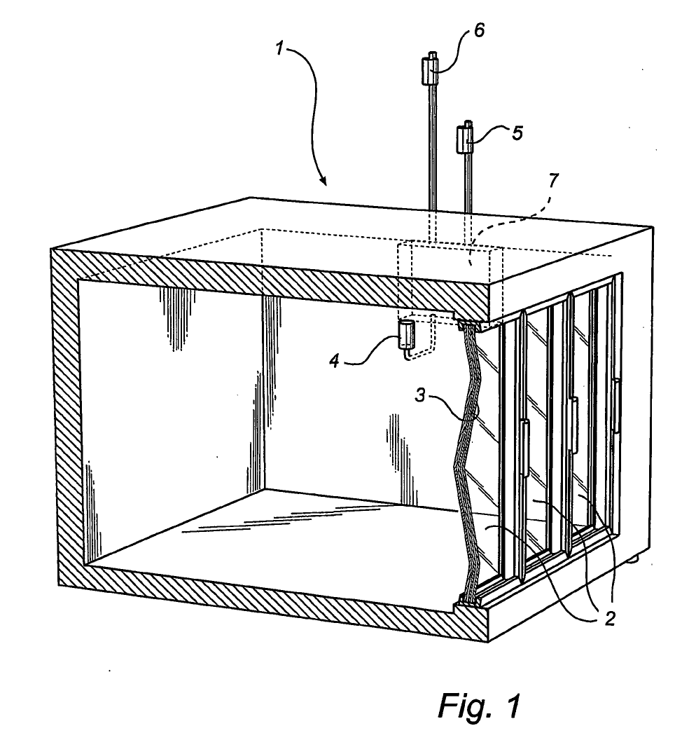

The invention will below be further described by way of an embodiment with reference to FIG. 1 which is a cross-sectional view of a cold-storage/freezer space with a system according to the present invention.

### DESCRIPTION OF PREFERRED EMBODIMENTS

The cold-storage/freezer space 1 in FIG. 1 comprises doors 2 with three sheets of glass, the outer sheets of glass 3 being coated with a conductive layer on the side facing the cold-storage/freezer space 1, through which layer current is intended to be conducted to keep the doors 2 free of condensation. For optimal control of the supply of power to the doors 2, a system according to the present invention is connected. The system comprises a temperature sensor 4 in the cold-storage/freezer space, a temperature sensor 5 outside the cold-storage/freezer space, a moisture sensor 6 outside the cold-storage/freezer space and a control unit 7. The temperature sensors 4, 5 and the moisture sensor 6 are connected to the control unit 7. The control unit 7 converts the signals from the sensors and calculates by these input signals the required power to keep the doors 2 free of condensation. The control unit 7 is programmed with a program which takes an experience curve for the specific doors 2 that are used into consideration. The control unit 7 thus is also connected to the doors 2.

In a preferred embodiment, no functions are to be programmed or read by the users, usually shop assistants. The control unit has no buttons and no display. Only indicator lamps (light-emitting diodes, not shown) indicate the operating status. A green light-emitting diode indicates that the unit is being supplied with power and functions properly. This light-emitting diode changes colour to a red flashing light in case of error. A yellow light-emitting diode indicates that power is being pulsed out.

The sensors 4, 5, 6 are arranged in capsules in such a manner that they give a representative value of the temperatures and the moisture content respectively. The supply of power to the sensors 4, 5, 6 is isolated from the mains voltage for reasons of security. The consumption of power causes so little self-heating that it does not affect the value of the temperature sensors.

The control unit 7 comprises a module (not shown), which supplies power to the control unit 7 and the sensors 4, 5, 6. The control unit 7 supplies power to the doors 2 via the module by giving the module a logic signal when power is to be supplied. If the control signal is not connected, no power is to be supplied. In case of error being indicated, the operation light (light-emitting diode) emits a red light and a transistor breaks an alarm circuit which is normally closed. The transistor of the alarm signal is optically isolated from internal electronics.

The program of the system can preferably be changed by the supplier for update of software. The control unit 7 is programmed via a five pole switch (not shown). This function is not intended for end consumers but may, by using suitable tools, be an aid for the service organisation for instance.

The system according to the present invention should cope with the temperature range for storing which is assumed to be between −35° C. and +40° C. On the cold side, the temperature usually varies between −35° C. and +25° C. Most of the time the temperature is cold and stable. In connection with defrosting and in the switched-off mode, the cold side assumes a temperature up to the temperature of the air in the shop. The temperature sensor on the cold side should thus be able to operate between −35° C. and +30° C. On the cold side, the moisture and temperature sensors should cope with temperatures between 0° C. and +40° C. If moisture can precipitate in the electronic parts, these parts should be secured in a convenient manner. Also the moisture content may vary and therefore a moist sensor should cope with 0% and 100% relative humidity (RH).

It will be appreciated that many modifications of the above-described embodiments of the invention are conceivable within the scope of the invention as defined by the appended claims. For instance, as described above the temperature sensor in the cold-storage/freezer space may thus instead be placed, for instance, on the upper part of the frame. The sensing elements of the sensor are then preferably positioned so that the temperature of the doorframe does not affect the measured temperature. The conductive layer may also be arranged on an optional sheet of glass, for instance on the intermediate sheet of glass if the door has three sheets of glass. The control unit, or alternatively a separate circuit, is preferably arranged in such a manner that compensation for variations in the mains voltage can be given to provide the correct supply of power to the doors.

1. A system in connection with a cold-storage/freezer space, said cold-storage/freezer space comprising at least one door with at least two transparent sheets, a conductive layer being placed on one of the sheets to function as a heating element to keep said sheets free of condensation, the system comprising a moisture sensor and a temperature sensor on the side which is warm when using the cold-storage/freezer space, said sensors being connected to a control unit, said control unit regulating the supply of power to said conductive layer, wherein
the system also comprises a second temperature sensor in said cold-storage/freezer space, i.e. on the side which is cold when using the cold-storage/freezer space, said second temperature sensor being connected to said control unit.

2. A system as claimed in claim 1, in which said control unit is arranged in the doorframe.

3. A system as claimed in claim 1, in which said control unit is a separate unit arranged separately from said door.

4. A system as claimed in claim 1, in which the control unit is programmed to keep the surface temperature on the outside of the sheet on the warm side above the dew point of the ambient air.

5. A system as claimed in claim 4, into which an experience curve is programmed.

6. A system as claimed in claim 1, in which a plug interface is connected to the control unit to allow reprogramming.

7. A system as claimed in claim 1, in which said second temperature sensor is arranged in the upper part of the doorframe.

8. A system as claimed in claim 1, in which light-emitting diodes are arranged to indicate the operating status of the system.

9. A system as claimed in claim 1, to which a change-over switch is connected to allow use of the same system for different types of doors and operating conditions.

10. A system as claimed in claim 1, in which said transparent sheet is a sheet of glass.
